(19) United States
(12) Patent Application Publication
(10) Pub. No.: US 2004/0037075 A1
(43) Pub. Date: Feb. 26, 2004

(54) Illumination lamp assembly having a hidden wire

(76) Inventor: Robert Wu, Taichung (TW)

Correspondence Address: Donald W. Meeker, 924 East Ocean Front #E, Newport Beach, CA, 92661, US

(21) Appl. No.: 10/233,348

(22) Filed: Aug. 23, 2002

(51) Int. Cl. F21S 4/00

(52) U.S. Cl. 362/227

(57) ABSTRACT

An illumination lamp assembly has a wire, a plurality of illuminant bulbs, a plurality of lamp holders installed on the wire. Each of the illuminant bulbs is disposed on the corresponding lamp holder. The wire has two cores, a plastic sheath covering and separating the cores, and a covering casing adhered on an outer layer of the plastic sheath.

### BACKGROUND OF THE INVENTION

The present invention relates to a hidden wire. More particularly, the present invention relates to an illumination lamp assembly having a hidden wire. Thus a color of the hidden wire is the same as a color of an environment.

A plurality of illuminant bulbs are installed on a wire. A controller controls a glitter of each illuminant bulb. However, a color of the wire is very different from a color of an environment. When the wire winds a Christmas tree, people will watch an artificial article of the wire. Therefore, the decoration of the wire on the Christmas tree is ugly.

### SUMMARY OF THE INVENTION

An object of the present invention is to provide an illumination lamp assembly which has a hidden wire to be concealed and camouflaged. Therefore, a color of the hidden wire and a color of an environment are the same.

### BRIEF DESCRIPTION OF THE DRAWINGS

FIG. 1 is a perspective view of an illumination lamp assembly having a hidden wire of a preferred embodiment in accordance with the present invention; and

FIG. 2 is an enlarged view of circle A in FIG. 1.

### DETAILED DESCRIPTION OF THE INVENTION

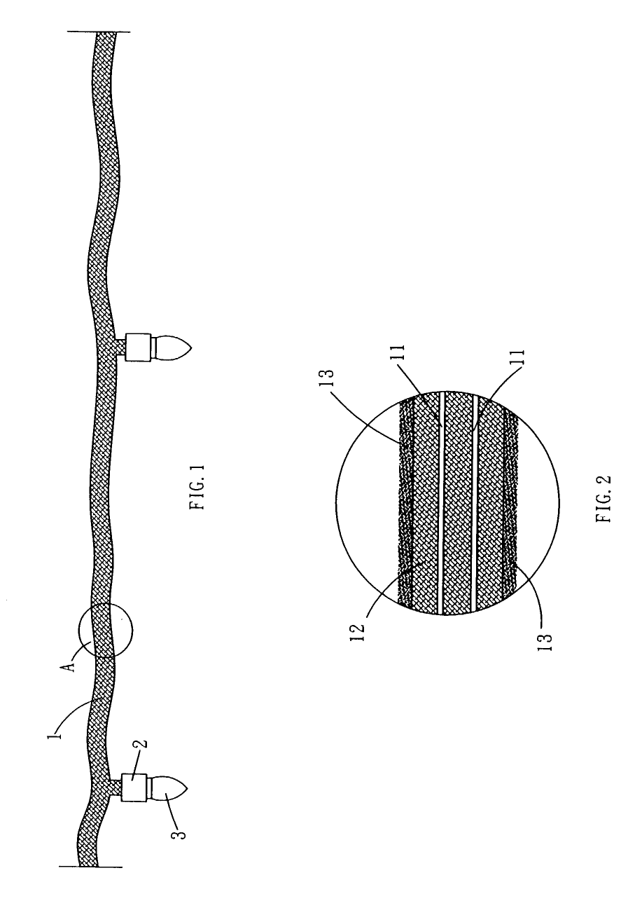

Referring to FIGS. 1 and 2, an illumination lamp assembly comprises a wire 1, a plurality of illuminant bulbs 3, a plurality of lamp holders 2 installed on the wire 1. Each of the illuminant bulbs 3 is disposed on the corresponding lamp holder 2.

The wire 1 has two cores 11, a plastic sheath 12 covering and separating the cores 11, and a covering casing 13 adhered on an outer layer of the plastic sheath 13.

The covering casing 13 is made of wood chips, electroplated chips or other materials.

A color of the covering casing 13 is the same as a color of an environment.

The wood chips or the electroplated chips can be adhered on an outer layer of the plastic sheath 13.

The wood chips or the electroplated chips can be mixed with adhesives to form a mixture. Then the mixture is poured into a spray gun in order to spray the mixture on an outer layer of the plastic sheath 13.

The present invention is not limited to the above embodiment but various modification thereof may be made. Furthermore, various changes in form and detail may be made without departing from the scope of the present invention.

I claim:

1. An illumination lamp assembly comprising a wire, a plurality of illuminant bulbs, a plurality of lamp holders installed on the wire, and each of the illuminant bulbs disposed on the corresponding lamp holder, characterized in that:
the wire has two cores, a plastic sheath covering and separating the cores, and a covering casing adhered on an outer layer of the plastic sheath.

2. The illumination lamp assembly as claimed in claim 1, wherein the covering casing is made of wood chips.

3. The illumination lamp assembly as claimed in claim 1, wherein the covering casing is made of electroplated chips.
